(19) United States
(12) Patent Application Publication
(10) Pub. No.: US 2026/0180668 A1
(43) Pub. Date: Jun. 25, 2026

(54) HIGH FREQUENCY SIGNAL BOOSTER IN RADIO FREQUENCY CIRCUIT

(71) Applicant: TP-LINK SYSTEMS, INC., Irvine, CA (US)

(72) Inventors: Taewook Kim, San Jose, CA (US); Changhui Hu, Sunnyvale, CA (US)

(73) Assignee: TP-LINK SYSTEMS, INC., Irvine, CA (US)

(21) Appl. No.: 19/000,535

(22) Filed: Dec. 23, 2024

(51) Int. Cl. H04B 7/155; H04B 1/00; H04B 1/40

(52) U.S. Cl. CPC H04B 7/15507; H04B 1/0082; H04B 1/40

(57) ABSTRACT

In some embodiments, an apparatus for communication in a wireless network includes a radio frequency (RF) circuitry. The RF circuitry includes one or more transceivers and a signal booster. The signal booster is coupled to the one or more transceivers to provide boosted high frequency signal to the transceivers based on a local oscillator signal received via a transmission line. The signal booster includes an amplifier including a pair of transistors cross-coupled each other in cascode. This configuration results in a reduced impedance of the signal booster, thus provides an improved Q value for the high frequency signal provided to the transceivers, without incurring additional power consumption as in existing systems. The signal booster can be implemented in any access point or client device in a wireless communication network such as IEEE 802.11.

### FIELD

This technology relates to wireless communication network, and more particularly to high frequency signal booster in radio frequency circuitry.

### BACKGROUND

In wireless communication, radio frequency (RF) circuitry is used to receive and transmit RF signals from/to the air. Depending on the given protocol, the RF signals can be in high frequency, e.g., in the gigahertz range. For example, wireless local area network (WLAN) protocols, such as Institute for Electrical and Electronics Engineers (IEEE) 802.11, allow for transmission of RF signals in 2.4 GHz and 5 GHz. As such, RF circuitry or components thereof, e.g., receivers or transmitters, need to operate in high frequencies. Typically in RF circuitry, stable high frequency signals are provided, e.g., using a local oscillator.

In RF circuitry, high frequency signals may be generated using a voltage controlled oscillator (VCO) and frequency multiplier that multiplies the frequency generated by the VCO, and transmitted to a transceiver (including receiver and transmitter). Providing high frequency signals to receivers or transmitters may require distributing local oscillator high frequency signals over a distance (e.g., a few millimeters), which may degrade the signals. Thus, high frequency boosting techniques may be used before high frequency signals are provided to receivers or transmitters.

### SUMMARY

The present disclosure relates to techniques for boosting high frequency signal. In an embodiment, an apparatus for communication in a wireless network, the apparatus includes a radio frequency (RF) circuitry. The RF circuitry includes one or more transceivers and a signal booster. The one or more transceivers are respectively coupled to one or more antennas to transmit or receive RF signals, wherein each of the one or more transceivers is configured to convert between the RF signals and baseband signals based in part on a high frequency signal. The signal booster is coupled to the one or more transceivers to provide the high frequency signal based on a local oscillator signal received via a transmission line. The signal booster includes a pair of transistors each comprising a respective gate, drain, and source. The pair of transistors are cross-coupled each other in cascode, where (1) drains/sources of the pair of transistors are coupled respectively to a first output terminal and a second output terminal, the first output terminal and the second output terminal configured to provide the high frequency signal; (2) sources/drains of the pair of transistors are coupled respectively to a first line and a second line of the transmission line to receive the local oscillator signal; and (3) gates of the pair of transistors are cross-coupled respectively to the second output terminal and the first output terminal.

In an embodiment, a radio frequency (RF) circuitry includes: one or more transceivers and a signal booster. The one or more transceivers are respectively coupled to one or more antennas to transmit or receive RF signals, wherein each of the one or more transceivers is configured to convert between the RF signals and baseband signals based in part on a high frequency signal. The signal booster is coupled to the one or more transceivers to provide the high frequency signal based on a local oscillator signal received via a transmission line. The signal booster includes a pair of transistors each comprising a respective gate, drain, and source. The pair of transistors are cross-coupled each other in cascode, where (1) drains/sources of the pair of transistors are coupled respectively to a first output terminal and a second output terminal, the first output terminal and the second output terminal configured to provide the high frequency signal; (2) sources/drains of the pair of transistors are coupled respectively to a first line and a second line of the transmission line to receive the local oscillator signal; and (3) gates of the pair of transistors are cross-coupled respectively to the second output terminal and the first output terminal.

In an embodiment, a high frequency signal booster for use in a wireless transceiver includes an amplifier. The amplifier includes a pair of transistors each comprising a respective gate, drain, and source. The pair of transistors are cross-coupled each other in cascode, where (1) sources/drains of the pair of transistors are coupled to a transmission line to receive a local oscillator signal; (2) drains/sources of the pair of transistors are coupled to an output terminal configured to provide a boosted high frequency signal based on the local oscillator signal; and (3) gates of the pair of transistors are cross-coupled respectively to the second output terminal and the first output terminal.

### BRIEF DESCRIPTION OF DRAWINGS

Additional embodiments of the disclosure, as well as features and advantages thereof, will become more apparent by reference to the description herein taken in conjunction with the accompanying drawings. The components in the figures are not necessarily to scale. Moreover, in the figures, like-referenced numerals designate corresponding parts throughout the different views.

FIG. 1 illustrates a wireless communication network, according to some embodiments.

FIG. 2 is a schematic diagram of an example RF circuit including two or more transceivers, according to some embodiments.

FIG. 3 is a schematic diagram of an example high frequency signal booster in existing systems.

FIG. 4 is a schematic diagram of an example high frequency signal booster, according to some embodiments.

FIGS. 5A-5B show comparison of impedance between a prior art signal booster and example signal booster shown in FIG. 4.

FIGS. 6A-6B show comparison of simulated Q values of boosted signal between a prior art signal booster and example signal booster shown in FIG. 4.

FIGS. 7A-7B show comparison of simulated spurs between a prior art signal booster and example signal booster shown in FIG. 4.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of the invention is thereby intended. It should be further appreciated that the embodiments described herein may be implemented in any of numerous ways. Examples of specific implementations are provided below for illustrative purposes only. It should be appreciated that these embodiments and the features/capabilities provided may be used individually, all together, or in any combination of two or more, as aspects of the technology described herein are not limited in this respect.

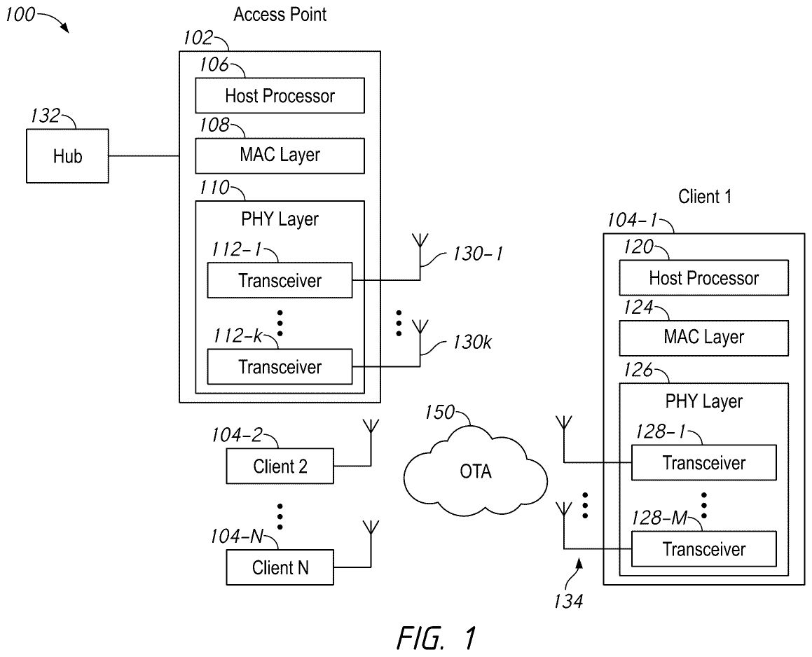

FIG. 1 illustrates a wireless communication network, according to some embodiments. In some embodiments, a wireless communication network 100 (e.g., WLAN) may facilitate communications between one or more access point (AP) device (e.g., 102) and one or more client devices (e.g., 104-1, 104-2, . . . 104-N). Each of the AP and client devices may be configured to receive or transmit frames (packets) from/to another device (e.g., AP or client devices) via over the air (OTA) medium (e.g., 150). These communication devices may be communicating with each other in a communication protocol, e.g., IEEE 802.11, or other suitable wireless protocols.

As shown in FIG. 1, AP device 102 may include one or more antennas (e.g., 130-1, . . . 130-K) configured to transmit or receive radio frequency (RF) signals to/from other devices in the wireless communication network 100. AP device 102 may include a physical layer 110, a MAC layer 108, and a host processor 106, which are configured to generate or process RF signals in lower to upper network layers, respectively. For example, PHY 110 may be configured to implement physical layer functions. PHY 110 may also include one or more transceivers (e.g., 112-1, . . . 112-K) configured to convert between baseband signals and RF signals, where RF signals are transmitted or received via the one or more antennas, e.g., 130-1, . . . 130-K.

In FIG. 1, the MAC 108 may be configured to implement MAC layer functions including processing frames (packets) received from the PHY layer and converting to data frames for upper layer(s), or vice versa. Host processor 106 may be coupled to MAC 108 and PHY 110 to process data via respective layers. Host processor 106 may also be configured to implement one or more applications and transmit/receive data to/from MAC 108.

As shown in FIG. 1, each of the components, e.g., host processor 106, MAC 108, PHY 110, as well as transceivers (112-1, . . . 112-K) may include circuitry, e.g., one or more integrated circuits (ICs). Thus, one or more functions of MAC and PHY layers may be implemented in hardware. Alternatively, and/or additionally, one or more functions of MAC and PHY layers may be implemented in software, e.g., via executing programing instructions (e.g., stored in memory). For example, each of the MAC 108 and PHY 110 may include one or more processors, e.g., CPUs, to execute programming instructions in a memory.

With further reference to FIG. 1, AP device 102 may be connected to a hub 132 (e.g., a wired router, a modem) which provides the Internet services (e.g., via an ISP). AP device 102 may provide Internet, via hub 132, to one or more client devices (e.g., 104-1, 104-2, . . . 104-N) that are connected to the AP device wirelessly, e.g., via OTA medium 150. Each of the client devices may have a similar configuration as the AP device 102. For example, client device 104-1 may include a host processor 120, a MAC layer 124, a PHY layer 126.

Similar to AP device 102, a client device (e.g., 104-1, 104-2, . . . 104-N) may include one or more antennas (e.g., 134) configured to transmit or receive RF signals to/from other devices in the wireless communication network 100. PHY layer 126, MAC layer 124, and host processor 120 may be configured to generate or process RF signals in lower to upper network layers, respectively. For example, PHY layer 126 may be configured to implement physical layer functions. PHY layer 126 may include one or more transceivers (e.g., 128-1, ... 128-M) configured to convert between baseband signals and RF signals, where RF signals are transmitted or received via the one or more antennas 134.

In FIG. 1, MAC layer 124 may be configured to implement MAC layer functions including processing frames (packets) received from the PHY layer and converting to data frames for upper layer(s), or vice versa. Host processor 120 may be coupled to the MAC layer 124 and PHY layer 126 to process data via respective layers. Host processor 120 may also be configured to implement one or more applications and transmit/receive data to/from MAC layer 124.

Similar to AP device 102, each of the components in a client device, e.g., host processor 120, MAC layer 124, PHY layer 126, as well as transceivers (128-1, . . . 128-M) may include circuitry, e.g., one or more integrated circuits (ICs). Thus, one or more functions of MAC and PHY layers may be implemented in hardware. Alternatively, and/or additionally, one or more functions of MAC and PHY layers may be implemented in software, e.g., via executing programing instructions (e.g., stored in memory) by MAC layer 124, PHY layer 126, host processor 120, or any other suitable processors. Client devices 104-2, . . . 104-N may each have a similar configuration as client device 104-1. Although one AP device 102 is shown in FIG. 1, it is appreciated that there can be multiple AP devices in the wireless communication network 100. Further, any suitable number of client device may be possible as supported in current or later developed protocols.

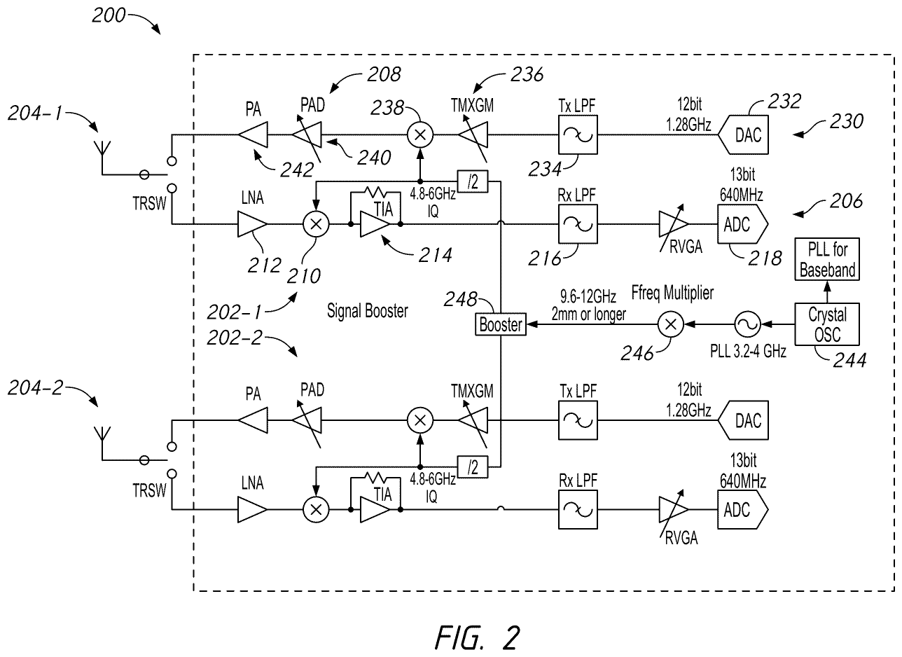

A device in the wireless network 100 (e.g., 102, 104) may thus have RF circuit including one or more transceivers (including receivers and transmitters) respectively coupled to one or more antennas. FIG. 2 is a schematic diagram of an example RF circuit 200 including two or more transceivers, according to some embodiments. In some embodiments, RF circuit 200 may be implemented in transceiver(s) of any wireless communication device (e.g., 112, 128 in FIG. 1). In the example configuration shown in FIG. 2, RF circuit 200 includes transceiver 202-1, 202-2, respectively coupled to antennas 204-1, 204-2. In these transceivers, high frequency signal may be mixed with incoming RF signal to provide a new signal at an intermediate frequency for processing before digitized via analog-to-digital converter (ADC). Conversely, the digital signal to be transmitted is converted to analog signal via digital-to-analog converter (DAC), then modulated with high frequency signal, e.g., 5 GHz to be transmitted to OTA via a corresponding antenna.

In non-limiting examples in FIG. 2, transceiver 202-1 may include a receiver 206 and transmitter 230. Receiver 206 may include mixer 210 configured to demodulate the incoming RF signal with a high frequency signal (e.g., downconvert RF signal to baseband signal for processing). Receiver 206 may further process the demodulated signal. For example, receiver 206 may include a low noise amplifier (LNA, 212) coupled to mixer 210, which may be coupled to a transimpedance amplifier (TIA, 206). Receiver 206 may further include ADC 218 to digitize the processed analog signal into digital signal. In some embodiments, receiver low pass filter (Rx LPF, 216) and receiver variable gain amplifier (RVGA, 220) may be provided to process the signal from TIA 206 before being digitized at ADC 218.

In FIG. 2, transmitter 230 may include DAC 232 configured to convert digital signal to be transmitted into analog signal. Transmitter low pass filter (Tx LPF, 234) may be coupled to DAC 232 may be coupled to Tx LPF 234 and mixer 238, which may be configured to modulate signal with a high frequency signal (e.g., upconvert a baseband signal to RF signal for transmission). Transmitter 230 may include power amplifier (PA, 242) and/or power amplifier driver (PAD, 240) to drive the modulated signal at an appropriate power for transmission. In some embodiments, transmitter 230 may also include a transmitter mixer gm (TMXGM, 236) coupled to the Tx LPF 234 and the mixer 238. Other transceiver(s), e.g., 202-2 may be configured in a similar manner as transceiver 202-1.

In some embodiments, the high frequency signal provided to the transceivers (e.g., at nodes f₁, f₂), may be obtained from a local oscillator signal or is a derivative signal of the local oscillator signal. For example, local oscillator signal may be provided by a voltage-controlled oscillator (VCO), e.g., a crystal OSC 224. As shown in FIG. 2, local oscillator high frequency signal provided to the transceiver may have a frequency at 5 GHz, which may be provided by a local crystal oscillator (OSC) 244. In some embodiments, crystal oscillator 244 may be a VCO (voltage-controlled oscillator) which generates periodic AC clock signals for which the frequency may be determined by the voltage. Whereas the frequency range of a VCO may not be wide enough to accommodate a desired frequency in wireless communication, a frequency multiplier may be used.

In some embodiments, RF circuit 200 may include a high frequency multiplier 246 to provide a high frequency signal of which the frequency may be a multiplication of that of the local oscillator signal. In non-limiting examples, the frequency multiplier 246 may be a tripler that provides signals at three times (3×) the frequency of the signal provided by the crystal OSC 244.

With further reference to FIG. 2, the high frequency signal provided to the transceivers may be transmitted via long distance from the VCO within the circuit, e.g., over 2 millimeters. Distribution of local oscillator signal over a long distance in a RF circuit may cause the signal to degrade, such as having a low Q value.

In some embodiments, RF circuit 200 may also include a high frequency signal booster 248 configured to amplify the high frequency signal with an improved Q value before being provided to the transceiver. High frequency signal booster may address the issue in long distance transmission of high frequency signal, e.g., in the gigahertz range. With a high frequency signal booster, the amplitude of the signal at a resonant peak, e.g., 12 GHz may be boosted whereas the amplitude of the signal at other frequencies may be suppressed. As a result, Q value of the signal is improved.

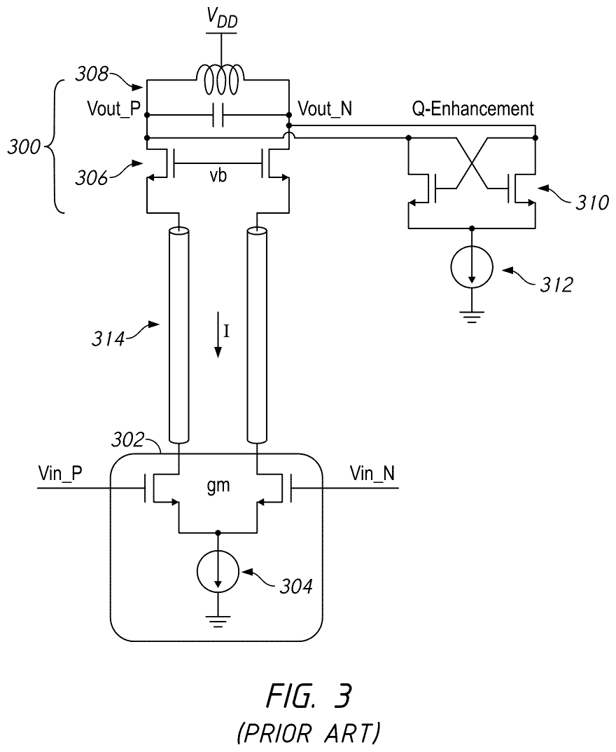

The inventors have recognized and acknowledged that existing high frequency signal boosters suffer from high complexity of circuitry and extra power consumption. FIG. 3 is a schematic diagram of an example high frequency signal booster in existing systems, such as a common-gate amplifier based signal booster. In FIG. 3, high frequency voltage signal, e.g., differential signal v_{in_P} and v_{in_N}, is converted to current signal I using a current source 304, where current I is carried through long distance transmission line 314 to the transceiver(s). At the end of the transmission line, a high frequency signal booster 300 includes a common-gate amplifier 306, which includes a pair of transistors (e.g., FET) with common gates. The output of the amplifier 306, e.g., v_{out_P} and v_{out_N}, is provided with a load circuit 308, which includes a LC circuit.

In existing systems, there are several approaches in improving the Q value of high frequency signal. For example, the current in the source 304 may be increased, resulting in an increased current transmitted through the transmission line 314. The increased current results in higher amplification of the signal. This approach, however, results in higher power consumption, for example, from the increased current in current source 304. Other approaches include using Q-enhancement circuit 310. For example, Q-enhancement circuit 310 is coupled in parallel to a signal booster. As shown in FIG. 3, Q-enhancement circuit 310 includes an external current source 312. This yields higher current and thus higher signal amplification in booster 306. This approach, again, results in higher complexity of the circuitry in the signal booster, as well as increased power consumption (e.g., due to the current source 312).

In other existing systems, multiple buffers may be provided along a long transmission line to boost the signal traveling through the long distance. For example, a buffer may be provided at every 100 micrometers (μm). Similar to other approaches described above, this existing approach has the drawback in additional power consumption in the circuit. For example, a transmission line of 500 μm would require 5 buffers. A transmission line of 2 mm would require about 20 buffers, resulting in significant power consumption.

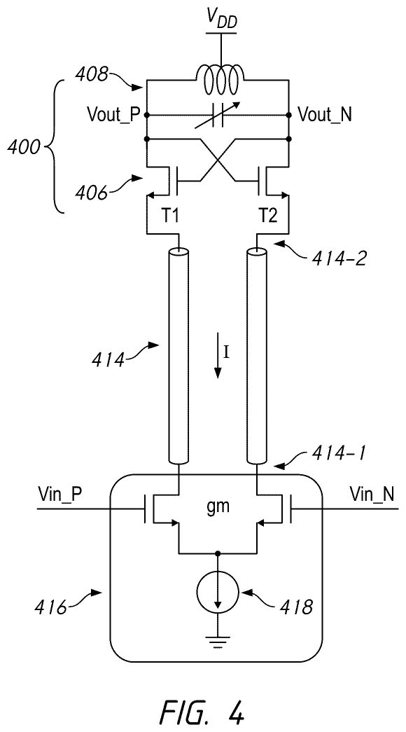

Accordingly, the inventors have developed improved high frequency signal booster. FIG. 4 is schematic diagram of an example high frequency signal booster 400, according to some embodiments. In some embodiments, high frequency signal booster 400 may be implemented in signal booster 248 in the RF circuit 200 (FIG. 2). As shown in FIG. 4, signal booster 400 may include an amplifier 406 configured to receive local oscillator signal (e.g., current I) from long transmission line 414. Amplifier 406 may include a pair of cross-coupled transistors T1, T2. In some examples, transistors T1, T2 may be field effect transistor (FET). Each of transistors T1, T2 may include a respective gate, drain, and source.

In FIG. 4, T1 and T2 may be cross-coupled in cascode. For example, drains/sources of the pair of transistors T1, T2 may be coupled respectively to the positive output terminal V_{out_P} and negative output terminal V_{out_N}, where V_{out_P} and V_{out_N} provide a differential high frequency output signal. Sources/drains of the pair of transistors T1, T2 may be coupled respectively to a first line and a second line of the transmission line 414 to receive the local oscillator signal. Gates of the pair of transistors T1, T2 may be cross-coupled respectively to the negative output terminal V_{out_N} and positive output terminal V_{out_P}.

Between the differential output terminals is provided a load circuit 408. In non-limiting examples, load circuit 408 may include a LC circuit configured to tune the resonance frequency of the signal booster to match a desired frequency, e.g., 12 GHz. In this LC circuit, the resonance frequency may be determined based on the inductance value of inductor L and the capacitance value of capacitor C. For example, fᵣₑₛ=1/(2π\sqrt{LC}).

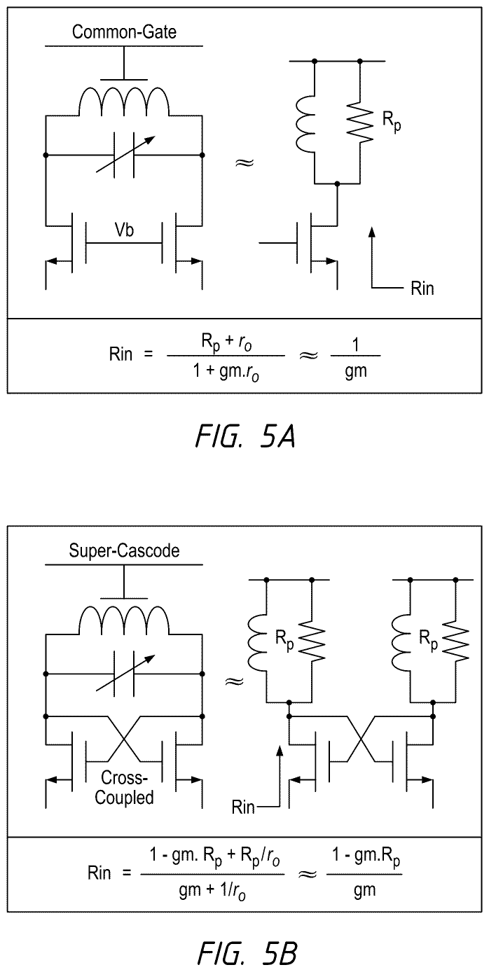

In the configuration in FIG. 4, the high frequency signal at the output terminal V_{out_P} and V_{out_N} may be boosted based on a local oscillator signal traveling through the transmission line 414. As shown, the sources/drains of the pair of transistors T1, T2 are coupled to a first end (e.g., 414-2) of the transmission line 414. The transmission line 414 may be a differential line comprising at least two lines for carrying a differential signal. As shown, the sources/drains of transistors T1, T2 may be coupled respectively to the two lines of transmission line 414. The other end (e.g., 414-1) of the transmission line 414 may be coupled to a converter circuitry 416, which may be coupled to a current source 418 and configured to provide the local oscillator signal as a current I to the transmission line. In FIG. 4, local oscillator signal may be provided to the input terminals V_{in_P} and V_{in_N} and converted to current signal I to be transmitted through the transmission line. In the configuration shown in FIG. 4, signal booster 406 can yield a lower impedance in comparing that of signal booster in existing systems. FIGS. 5A-5B show comparison of impedance between a prior art signal booster, e.g., common-gate configuration (see FIG. 3), and the example signal booster 400 shown in FIG. 4. In the calculation shown in FIGS. 5A-5B, the input impedance of the common-gate based signal booster in existing systems is 1/gm, whereas the input impedance of signal booster 400 (FIG. 4) is (1−gm·Rₚ)/gm, where Rₚ is the parasitic resistance of the inductor L. As such, signal booster 400 has a reduced input impedance. This results in higher amplification without requiring increased current in the transmission line as in existing systems. This can achieve a higher Q value for the high frequency signal transmitted via the long transmission line without additional current consumption.

Returning to FIG. 4, in some variations, signal booster 400 may additionally include one or more switching transistors for improved controllability. For example, the one or more switching transistors may each be coupled to the transistors T1 and/or T2 in parallel, with common drains and sources. The one or more switching transistors may be selectively activated or deactivated, for example via control signals provided to the gates, from outside of the RF circuit. Activation or deactivation of the one or more switching transistors may enable controlling or stabilizing the signal booster by diverting the current in the transistors T1 and/or T2 via one or more switching transistors until the signal is stable and achieves an adequate amplitude.

Returning to FIG. 2, although a single signal booster 248 is shown to provide high frequency signal to two transceivers (e.g., 202-1, 202-2), it is appreciated that signal booster 248 may be coupled to multiple transceivers (e.g., more than two) and provide high frequency signal thereto. In other variations, multiple signal boosters may be provided and configured in a similar manner as signal booster 248, where each signal booster is coupled to a corresponding transceiver to provide high frequency therefor. For example, two signal boosters may be respectively coupled to transceivers 202-1, 202-2, where the two signal boosters are coupled to frequency multiplier 246 to receive the local oscillator signals.

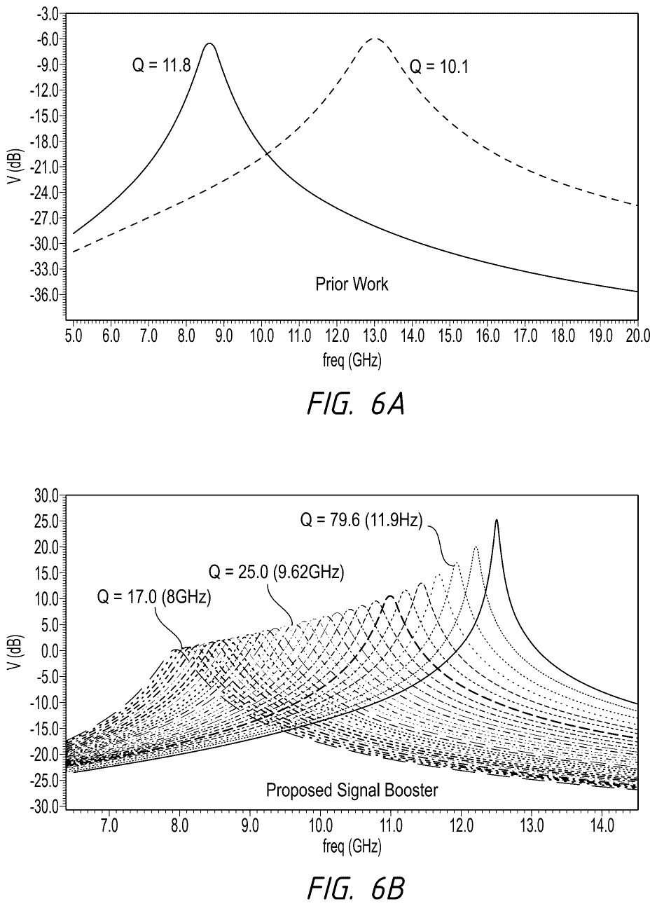

The various embodiments as described in FIGS. 1-5B provide improved signal Q values and spur levels over existing systems. FIGS. 6A-6B show comparison of simulated Q values of boosted signal between a prior art signal booster and example signal booster shown in FIG. 4, and show that the signal booster as described in the present disclosure provides higher Q values. As shown, the Q values of signal booster in existing systems is around 10-12 in the frequency range of 8-12 GHz, whereas the Q values of the signal booster as described in the present disclosure (e.g., in FIG. 4) is around 17-80 in the same frequency range.

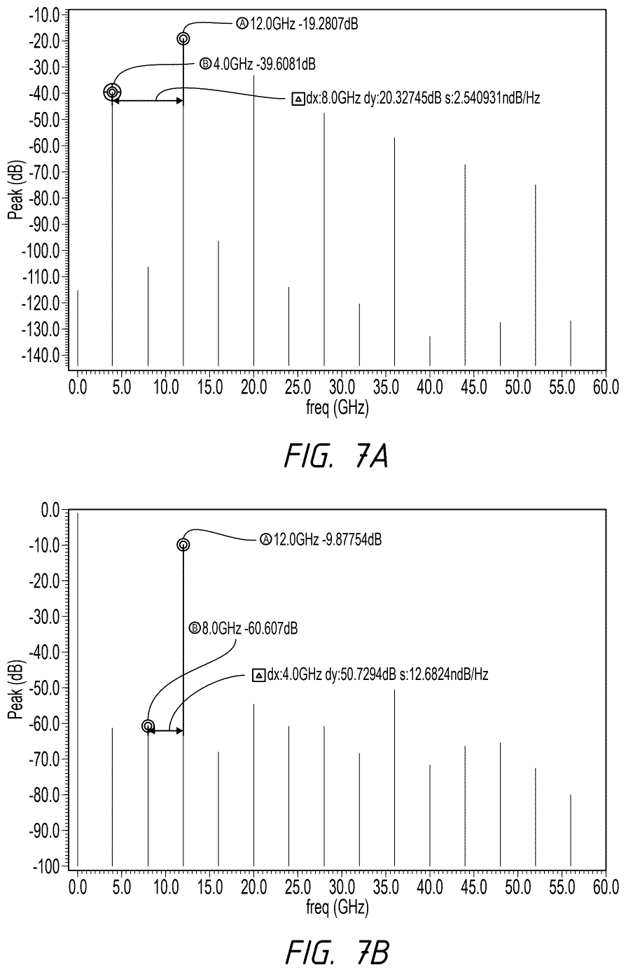

FIGS. 7A-7B show comparison of simulated spur levels between a prior art signal booster and example signal booster shown in FIG. 4, and show that the signal booster as described in the present disclosure provides higher spur levels between desired frequency and unwanted frequencies. As shown, the spur level (e.g., difference between the amplitudes of the signal at a primary frequency and non-primary frequency) in existing systems with respect to 12 GHz and 8 GHz is about 20.3 dBc, whereas the spur level in the signal booster as described in the present disclosure (e.g., in FIG. 4) is about 50.7 dBc.

Various embodiments described in the present disclosure provide advantages over existing systems in that embodiments of signal booster as described in the present disclosure provide a higher Q value and/or a higher spur level between desired and unwanted frequencies, without increasing the power consumption of the signal booster. This can be used to boost the signal at a desirable frequency range and suppress the signal in undesirable frequency range. The signal booster can be coupled to the transceivers in RF circuitry to overcome the degradation of local oscillator signal when traveling through long transmission lines.

The indefinite articles “a” and “an,” as used herein in the specification and in the claims, unless clearly indicated to the contrary, should be understood to mean “at least one.” As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This allows elements to optionally be present other than the elements specifically identified within the list of elements to which the phrase “at least one” refers, whether related or unrelated to those elements specifically identified.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the invention in detail, various modifications and improvements will readily occur to those skilled in the art. Such modifications and improvements are intended to be within the spirit and scope of the invention. Accordingly, the foregoing description is by way of example only, and is not intended as limiting.

1. An apparatus for communication in a wireless network, the apparatus comprising:
radio frequency (RF) circuitry comprising:
one or more transceivers respectively coupled to one or more antennas to transmit or receive RF signals, wherein each of the one or more transceivers is configured to convert between the RF signals and baseband signals based in part on a high frequency signal; and
a signal booster coupled to the one or more transceivers to provide the high frequency signal based on a local oscillator signal received via a transmission line, the signal booster comprising a pair of transistors each comprising a respective gate, drain, and source, wherein the pair of transistors are cross-coupled each other in cascode so that:
drains/sources of the pair of transistors are coupled respectively to a first output terminal and a second output terminal of the signal booster, the first output terminal and the second output terminal configured to provide the high frequency signal;
sources/drains of the pair of transistors are coupled respectively to a first line and a second line of the transmission line to receive the local oscillator signal; and
gates of the pair of transistors are cross-coupled respectively to the second output terminal and the first output terminal.

2. The apparatus of claim 1, wherein the signal booster further comprises a load circuit coupled to the first output terminal and the second output terminal and configured to tune a resonance frequency of the signal booster to a desired frequency.

3. The apparatus of claim 2, wherein the load circuit of the signal booster comprises an inductor and a capacitor coupled in parallel and configured so that the desired frequency is 12GHz.

4. The apparatus of claim 1, wherein the pair of transistors of the signal booster each comprise a field effect transistor (FET).

5. The apparatus of claim 1, wherein:
the sources/drains of the pair of transistors of the signal booster are coupled to a first end of the transmission line; and
a converter circuitry is coupled to a second end of the transmission line to provide the local oscillator signal to the transmission line.

6. The apparatus of claim 5, wherein the converter circuitry is coupled to a current source and configured to provide the local oscillator signal as a current signal to the transmission line.

7. The apparatus of claim 1, wherein:
the signal booster is a first signal booster coupled to a first transceiver;
the high frequency signal is a first high frequency signal; and
the RF circuitry further comprises a second signal booster coupled to a second transceiver to provide a second high frequency signal based on the local oscillator signal received via the transmission line, the second signal booster comprising a pair of transistors each comprising a respective gate, drain, and source, wherein the pair of transistors are cross-coupled each other in cascode so that:
drains/sources of the pair of transistors of the second signal booster are coupled respectively to a first output terminal and a second output terminal of the second signal booster, the first output terminal and the second output terminal configured to provide the additional high frequency signal;
sources/drains of the pair of transistors of the second signal booster are coupled respectively to the first line and the second line of the transmission line to receive the local oscillator signal; and
gates of the pair of transistors of the second signal booster are cross-coupled respectively to the second output terminal and the first output terminal of the signal booster.

8. A radio frequency (RF) circuitry comprising:
one or more transceivers respectively coupled to one or more antennas to transmit or receive RF signals, wherein each of the one or more transceivers is configured to convert between the RF signals and baseband signals based in part on a high frequency signal; and
a signal booster coupled to the one or more transceivers to provide the high frequency signal based on a local oscillator signal received via a transmission line, the signal booster comprising a pair of transistors each comprising a respective gate, drain, and source, wherein the pair of transistors are cross-coupled each other in cascode so that:
drains/sources of the pair of transistors are coupled respectively to a first output terminal and a second output terminal of the signal booster, the first output terminal and the second output terminal configured to provide the high frequency signal;
sources/drains of the pair of transistors are coupled respectively to a first line and a second line of the transmission line to receive the local oscillator signal; and
gates of the pair of transistors are cross-coupled respectively to the second output terminal and the first output terminal.

9. The RF circuitry of claim 8, wherein the signal booster further comprises a load circuit coupled to the first output terminal and the second output terminal and configured to tune a resonance frequency of the signal booster to a desired frequency.

10. The RF circuitry of claim 9, wherein the load circuit comprises an inductor and a capacitor coupled in parallel and configured so that the desired frequency is 12 GHz.

11. The RF circuitry of claim 8, wherein the pair of transistors of the signal booster each comprise a field effect transistor (FET).

12. The RF circuitry of claim 8, wherein:
the sources/drains of the pair of transistors of the signal booster are coupled to a first end of the transmission line; and
a converter circuitry is coupled to a second end of the transmission line to provide the local oscillator signal to the transmission line.

13. The RF circuitry of claim 12, wherein the converter circuitry is coupled to a current source and configured to provide the local oscillator signal as a current signal to the transmission line.

14. The RF circuitry of claim 8, wherein:
the signal booster is a first signal booster coupled to a first transceiver;
the high frequency signal is a first high frequency signal; and
the RF circuitry further comprises a second signal booster coupled to a second transceiver to provide a second high frequency signal based on the local oscillator signal received via the transmission line, the second signal booster comprising a pair of transistors each comprising a respective gate, drain, and source, wherein the pair of transistors are cross-coupled each other in cascode so that:
drains/sources of the pair of transistors of the second signal booster are coupled respectively to a first output terminal and a second output terminal of the second signal booster, the first output terminal and the second output terminal configured to provide the additional high frequency signal;
sources/drains of the pair of transistors of the second signal booster are coupled respectively to the first line and the second line of the transmission line to receive the local oscillator signal; and
gates of the pair of transistors of the second signal booster are cross-coupled respectively to the second output terminal and the first output terminal of the signal booster.

15. A high frequency signal booster for use in a wireless transceiver, the signal booster comprising an amplifier comprising:
a pair of transistors each comprising a respective gate, drain, and source, wherein the pair of transistors are cross-coupled each other in cascode so that:
sources/drains of the pair of transistors are coupled to a transmission line to receive a local oscillator signal;
drains/sources of the pair of transistors are coupled to an output terminal configured to provide a boosted high frequency signal based on the local oscillator signal; and
gates of the pair of transistors are cross-coupled respectively to the second output terminal and the first output terminal.

16. The signal booster of claim 15, wherein the sources/drains of the pair of transistors are coupled respectively to a first line and a second line of the transmission line to receive the local oscillator signal, wherein the local oscillator signal is a differential signal.

17. The signal booster of claim 15, wherein the output terminal of the amplifier is configured to be coupled to the wireless transceiver to provide the boosted high frequence signal thereto, wherein the wireless transceiver is configured to convert between RF signals and baseband signals based in part on the boosted high frequency signal.

18. The signal booster of claim 15, wherein the signal booster further comprises a load circuit coupled to the output terminal of the amplifier and configured to tune a resonance frequency of the signal booster to a desired frequency.

19. The signal booster of claim 18, wherein the load circuit comprises an inductor and a capacitor coupled in parallel and configured tune the resonance frequency.

20. The signal booster of claim 15, wherein the local oscillator signal is provided using a current source through the transmission line.
